(19) United States
(12) Patent Application Publication
(10) Pub. No.: US 2025/0237844 A1
(43) Pub. Date: Jul. 24, 2025

(54) LENS BARREL AND IMAGING APPARATUS

(71) Applicant: CANON KABUSHIKI KAISHA, Tokyo (JP)

(72) Inventors: KENTA KOIWAI, Tochigi (JP); TOSHIHIRO OGAWA, Tokyo (JP); KENTA TAKAI, Kanagawa (JP); TADANORI OKADA, Tochigi (JP); HYOCHORU TANAKA, Tochigi (JP)

(21) Appl. No.: 19/034,060

(22) Filed: Jan. 22, 2025

(30) Foreign Application Priority Data
Jan. 23, 2024 (JP) 2024-008190

(51) Int. Cl. G02B 7/04

(52) U.S. Cl. CPC G02B 7/04

(57) ABSTRACT

A lens barrel has a first lens group configured to be movable in an optical axis direction, which is a direction along an optical axis, a second lens group configured to be adjacent to the first lens group in the optical axis direction, be movable in the optical axis direction, and have a movement range that overlaps with a movement range of the first lens group by a predetermined amount, a first holding member configured to hold the first lens group, a second holding member configured to hold the second lens group, a driving unit configured to move the first holding member in the optical axis direction, a first intermediate member and a second intermediate member configured to move by a driving force of the driving unit and transmit the driving force to the first holding member, a first biasing member configured to bias the first intermediate member toward the driving unit and bias the second intermediate member toward the first holding member, a second biasing member configured to bias the first holding member in the optical axis direction with respect to the second intermediate member, a guide shaft member configured to movably hold the second intermediate member and the first holding member and guide movement thereof, and a detection unit configured to detect a position of the second intermediate member in the optical axis direction and a unit to be detected. The second biasing member enables the first holding member to be retracted by at least the predetermined amount in a direction opposite to a side on which the second holding member is disposed with respect to the second intermediate member, and one of the detection unit and the unit to be detected is disposed on the second intermediate member.

### BACKGROUND

### Technical Field

The present disclosure relates to a lens barrel, and more particularly, to a lens barrel having a lens group that is moved manually or by an external driving unit and a lens group that is moved by an electrical driving unit, and an imaging apparatus including the lens barrel.

### Description of the Related Art

In order to reduce the shortest overall length of a zoom lens barrel, a technology is known that enables a configuration in which a second lens group that is moved manually or that is moved by an external driving unit enters a moving range of a first lens group that is moved by an electrical driving unit. In Japanese Patent Application Laid-Open No. 2023-136192, a first lens group that is manually moved in an optical axis direction, a first holding member that holds the first lens group, a second lens group that is moved by a driving force of a driving unit via an intermediate member, and a second holding member are provided. A lens barrel structure is disclosed in which if the first holding member interferes with the second holding member, a biasing member is displaced so as to absorb the impact between the lens groups. Additionally, a control method is disclosed that changes the control of the driving unit according to the amount of interference in order to improve the driving accuracy and the imaging quality. Japanese Patent Application Laid-Open No. 2023-012085 discloses a configuration in which origin detection is made possible even in an interference state by dividing an intermediate member into two members and positioning a unit to be detected in the second intermediate member.

### SUMMARY

An embodiment of the present invention provides a lens barrel that is advantageous in terms of, for example, downsizing a product and improving focus accuracy.

A lens barrel according to an embodiment of the present invention comprises: a first lens group configured to be movable in an optical axis direction, which is a direction along an optical axis; a second lens group configured to be adjacent to the first lens group in the optical axis direction, to be movable in the optical axis direction, and to have a movement range that overlaps with a movement range of the first lens group by a predetermined amount; a first holding member configured to hold the first lens group; a second holding member configured to hold the second lens group; a driving unit configured to move the first holding member in the optical axis direction; a first intermediate member and a second intermediate member configured to move by a driving force of the driving unit and transmit the driving force to the first holding member; a first biasing member configured to bias the first intermediate member toward the driving unit and bias the second intermediate member toward the first holding member; a second biasing member configured to bias the first holding member in the optical axis direction with respect to the second intermediate member; a guide shaft member configured to movably hold the second intermediate member and the first holding member and guide movement thereof; and a detection unit configured to detect a position of the second intermediate member in the optical axis direction and a unit to be detected, wherein the second biasing member enables the first holding member to be retracted by at least the predetermined amount in a direction opposite to a side on which the second holding member is disposed with respect to the second intermediate member, and wherein one of the detection unit and the unit to be detected is disposed on the second intermediate member.

Further features of the present invention will become apparent from the following description of exemplary embodiments with reference to the attached drawings.

### BRIEF DESCRIPTION OF THE DRAWINGS

FIG. 1 is a cross-sectional view of a lens barrel according to the first embodiment.

FIG. 2 is a diagram illustrating a movement locus of each lens group during zooming.

FIG. 3 is an exploded perspective view illustrating a holding structure of a fourth group lens barrel.

FIG. 4 is a perspective view illustrating a holding structure in a state in which a rack has been joined to the fourth group lens barrel.

FIG. 5 is a diagram showing a movement locus of the fourth lens group and the fifth lens group.

FIG. 6 is a cross-sectional view illustrating a state in which the fourth group lens barrel and the fifth group lens barrel do not interfere with each other.

FIG. 7 is a cross-sectional view illustrating a state in which the fourth group barrel and the fifth group barrel interfere with each other.

FIG. 8 is a perspective view showing a normal state of a part of the focus unit.

FIG. 9 is a cross-sectional view illustrating a normal state of the fourth group lens barrel and the rack holder.

FIG. 10 is a cross-sectional view illustrating an interference state between the fourth group lens barrel and the rack holder.

FIG. 11A and FIG. 11B are diagrams explaining downsizing due to the disposition of the scale in the optical axis direction according to the first embodiment.

FIG. 12 is a diagram explaining a relation between a sleeve hole 132a, a sleeve hole 132b, and a guide bar 123a.

FIG. 13 is a diagram illustrating the disposition of a scale holding unit in the direction orthogonal to the optical axis in the second embodiment.

FIG. 14 is a diagram illustrating an example of a configuration of an imaging apparatus.

FIG. 15A and FIG. 15B are diagrams explaining an increase in size due to the disposition of the scale in the optical axis direction.

### DESCRIPTION OF THE EMBODIMENTS

Hereinafter, preferred embodiments of the present invention will be explained in detail with reference to the accompanying drawings. Note that throughout the drawings, the same or corresponding parts are denoted by the same reference numerals, and redundant descriptions will be omitted.

### First Embodiment

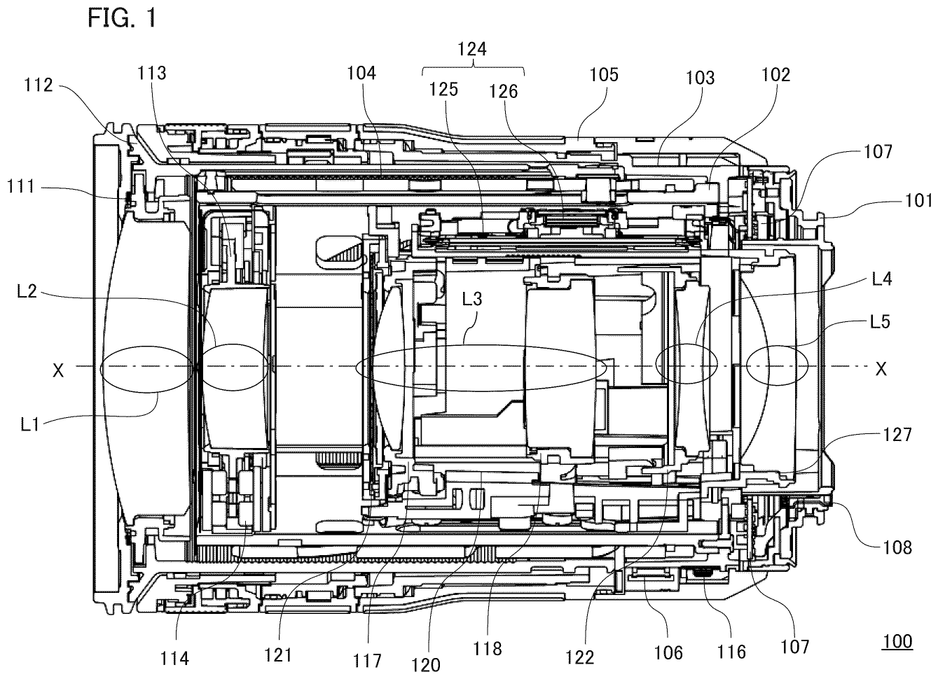

Hereinafter, a lens barrel 100 according to the first embodiment will be explained. FIG. 1 is a cross-sectional view of the lens barrel 100 according to the first embodiment. A line indicated by X-X in the drawing represents an optical axis.

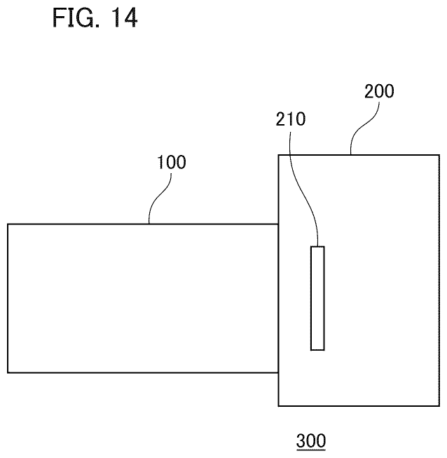

A mount 101 is a component fixed to a camera body 200 (illustrated in FIG. 14). A guide barrel 102 is integrally fixed to the mount 101 together with a fixed barrel 103. A cam ring 104 is held on the outer periphery of the guide barrel 102 so as to be rotatable about the optical axis. The cam ring 104 is connected to a zoom ring 105, which is rotatably held on the outer periphery of the fixed barrel 103, by a key member (not illustrated), and is configured to be integrally rotated by operating the zoom ring 105 from the outside.

A zoom sensor 106 serving as a focal length detection unit is a sensor that is attached to the fixed barrel 103 and electrically detects a rotation angle of the zoom ring 105. The zoom sensor 106 is electrically connected to a control substrate 107 that is disposed near the mount 101, and transmits focal length information during zooming to a control circuit. The control substrate 107 is electrically connected to a contact block 108, communicates with the camera body 200, and is supplied with power.

A first lens group L1 is fixed to a first group lens barrel 111, and the first group lens barrel 111 is fixed to a straight-movable barrel 112.

A second lens group L2 is held by a second group lens barrel 113, and the second group lens barrel 113 is held by a shift unit 114 so as to be movable in a plane orthogonal to the optical axis. The shift unit 114 includes an actuator for driving the second group lens barrel 113, a sensor that detects a driving amount, and the like. The shift unit 114 is fixed to the guide barrel 102 and is electrically connected to the control substrate 107. The control substrate 107 drives and controls the second group lens barrel 113 so that blur is corrected based on a blur signal detected by a blur sensor 116 (acceleration sensor) that is attached to the fixed barrel 103.

A third lens group L3 is held by a 3A group lens barrel 117 and a 3B group lens barrel 118, and both are fixed to a third group base lens barrel 120. The third group base lens barrel 120 holds an electromagnetic diaphragm unit 121, and the electromagnetic diaphragm unit 121 is electrically connected to the control substrate 107.

A fourth lens group L4 that serves as a first lens group is held by a fourth group lens barrel 122 that serves as a first holding member, and a fourth group lens barrel 122 is held by the guide bars 123 (123a and 123b), which are to be explained below, so as to be movable in a direction along the optical axis (in the optical axis direction) with respect to the third group base lens barrel 120. The fourth lens group L4 is a lens for focus adjustment and is movable in the optical axis direction. Specifically, the fourth lens group L4 is driven in the optical axis direction by a linear ultrasonic motor 124 that serves as a driving unit held by the third group base lens barrel 120 to change the focal length.

The linear ultrasonic motor 124 includes a fixed portion 125 and a movable portion 126, and drives the movable portion 126 in the optical axis direction by ultrasonically vibrating a piezoelectric element, which is a well-known technology. The piezoelectric element is electrically connected to the control substrate 107 by a flexible printed circuit board (not illustrated).

A fifth lens group L5 that serves as a second lens group is held by a fifth group lens barrel 127 that serves as a second holding member. The fifth lens group L5 is adjacent to the fourth lens group L4 in the optical axis direction, and is arranged on the image plane side of the fourth lens group L4.

The first lens group L1, the third lens group L3, and the fifth lens group L5 are lenses that move in the optical axis direction during zooming, and cam followers (not illustrated) are provided on the straight-movable barrel 112, the third group base lens barrel 120, and the fifth group lens barrel 127. Each cam follower is engaged with a straight groove that is provided in the guide barrel 102 and a cam groove that is provided in the cam ring 104, and the first lens group L1, the third lens group L3, and the fifth lens group L5 are configured to be capable of moving straight in the optical axis direction by rotating the cam ring 104.

Additionally, since the fourth lens group L4 for focus adjustment is held by the third group base barrel 120, the fourth lens group LA is driven in the optical axis direction by the linear ultrasonic motor 124 while moving together with the third group base lens barrel 120 during zooming.

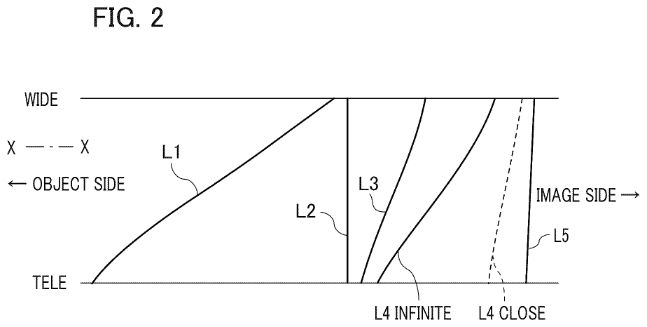

FIG. 2 is a diagram illustrating a movement locus of each lens group during zooming. In this drawing, a movement locus from the wide-angle end to the telephoto end with reference to the mount 101 is shown. Specifically, the first lens group L1, the third lens group L3, and the fifth lens group L5 move during zooming, and the second lens group L2 does not move during zooming. L4 INFINITE indicates a movement locus of the fourth lens group L4 in a state of being focused (in-focus) at infinity, and L4 CLOSE indicates a movement locus in a state of being focused at a predetermined close distance.

During zooming, the position information of the fourth lens group L4 that focuses on each focus position from infinity to the close distance at each focal length from the wide angle end to the telephoto end is stored as data. Based on the information and focal length information detected by the zoom sensor 106, the driving of the fourth group lens barrel 122 is controlled by the linear ultrasonic motor 124 so as to follow a line as shown in FIG. 2.

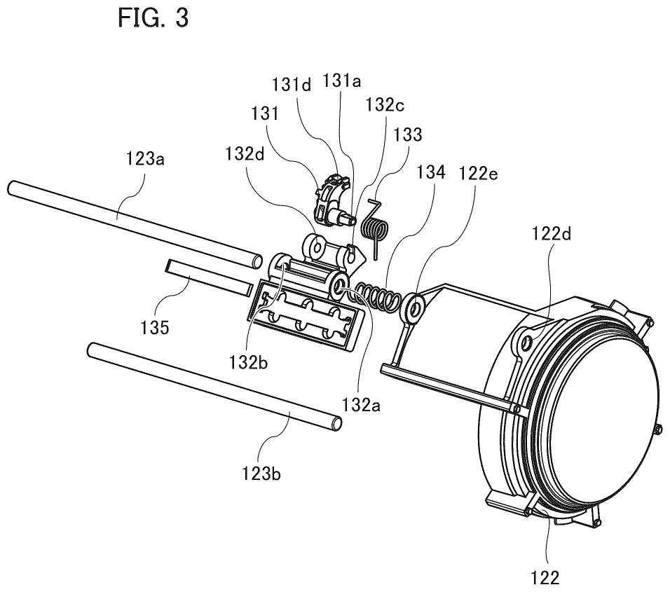

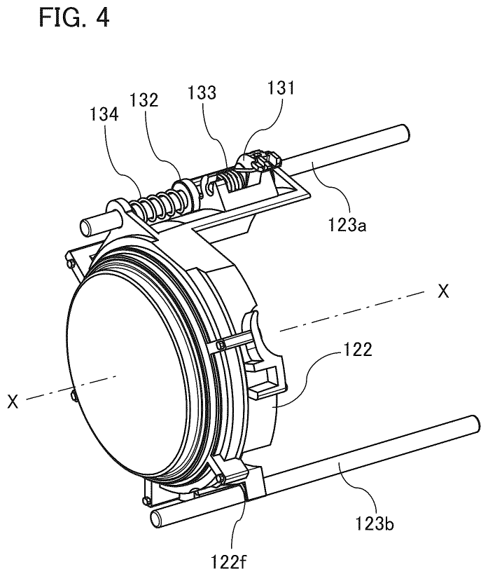

Next, a holding structure of the fourth group lens barrel 122 will be explained. FIG. 3 is an exploded perspective view showing a holding structure of the fourth group lens barrel 122. FIG. 4 is a perspective view illustrating a holding structure in a state in which a rack 131 is assembled to the fourth group lens barrel 122. In FIG. 3 and FIG. 4, both ends of each of the guide bar 123a and the guide bar 123b are fixed to the third group base barrel 120. The guide bar 123a is a guide shaft member, is inserted into a sleeve hole 122d that serves as a first holding member guide portion and a sleeve hole 122e that serves as a second holding member guide portion provided in the fourth group lens barrel 122, and also holds the fourth group barrel 122 so as to be movable in the optical axis direction. The guide bar 123b is engaged with a U-shaped groove 122f of the fourth group lens barrel 122 to prevent the fourth group lens barrel 122 from rotating about the guide bar 123a.

In the present embodiment, the rack 131 (first intermediate member) and the rack holder 132 (second intermediate member) are each configured as an intermediate member.

The rack holder 132 has the sleeve hole 132a and the sleeve hole 132b that serve as intermediate member guide portions. The rack holder 132 is held by the guide bar 123a so as to be movable in the optical axis direction by inserting the guide bar 132a into the sleeve hole 132b and the sleeve hole 123a. The contact portion (not illustrated) comes into contact with the fourth group lens barrel 122 to prevent the rack holder 132 from rotating about the sleeve hole. A compression coil spring 134 that serves as a second biasing member is an elastic member that is disposed in a space between the fourth group lens barrel 122 and the rack holder 132 in the optical axis direction, and the guide bar 123a is inserted into a spiral coil portion. One end of the compression coil spring 134 urges the fourth group lens barrel 122 toward the imaging surface side in the optical axis direction, and the other end of the compression coil spring 433 urges the rack holder 132 toward the sleeve hole 122e of the fourth group lens barrel 122. That is, the compression coil spring 134 urges the fourth group lens barrel 122 toward the imaging surface side in the direction along the optical axis with respect to the rack holder 132. Therefore, if the rack holder 132 moves in the optical axis direction, the fourth group lens barrel 122 moves integrally with (in conjunction with) the rack holder 132 in the same direction as the rack holder 132. Note that the second biasing member only needs to be capable of biasing the fourth group lens barrel 122 in the direction along the optical axis with respect to the rack holder 132, and a tension coil spring or a magnet may be used as the second biasing member instead of the compression coil spring 134.

In the rack 131, a V-shaped groove portion 131d at the distal end is engaged with a projection portion (not illustrated) that is provided in the movable portion 126 of the linear ultrasonic motor 124, and a rotating shaft portion 131a is engaged with a sleeve hole 132c of the rack holder 132. A rack spring 133 that serves as a first biasing member is disposed in a space between the rack 131 and the rack holder 132, and the rotating shaft portion 131a is inserted into a spiral coil portion. One end of the rack spring 133 biases the rack holder 132 toward the imaging surface side in the optical axis direction, and the other end the rack spring 133 biases the rack 131 toward a sleeve hole 132d of the rack holder 132. Therefore, if the rack 131 moves in the optical axis direction, the rack holder 132 moves integrally with (in conjunction with) the rack 131 in the same direction as the rack 131. Additionally, one end of the arm portion of the rack spring 133 comes into contact with the rack 131 to urge the rack 131 toward the movable portion 126 of the linear ultrasonic motor 124, and similarly, the other end of the arm portion of the rack spring 133 comes into contact with the rack holder 132 to urge the rack holder 132 toward the fourth group lens barrel 122. Therefore, even if there is a variation in the component part accuracy, the driving force of the linear ultrasonic motor 124 can be transmitted to the fourth group lens barrel 122 without rattling caused by the urging force.

As explained above, the intermediate member is formed into two members and the urging member is formed into two members, and therefore, urging is stably performed in the direction orthogonal to the optical axis even at the time of interference. Additionally, since there is no difference in diameter at the portion where the compression coil spring 134 is inserted and the compression coil spring is not moved to one side, abrasion, abnormal noises, deformation, and catching do not occur.

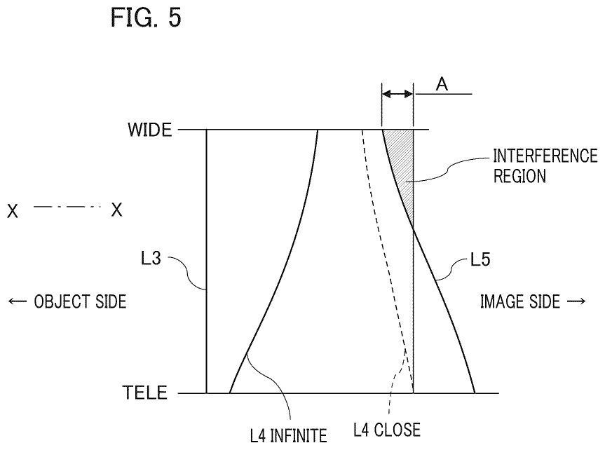

Next, a driving method for the focus lens according to the present embodiment will be explained. FIG. 5 is a diagram showing a movement locus of the fourth lens group L4 and the fifth lens group L5. In this drawing, the movement locus of the fourth lens group L4 and the fifth lens group L5 from the wide angle end to the telephoto end are shown with the third lens group L3 arranged at a predetermined position as a reference. In the same manner as in FIG. 2, L4 INFINITE indicates a movement locus of the fourth lens group L4 in a state in which the focus is adjusted to infinity (in-focus), and L4 CLOSE indicates a movement locus in a state in which the focus is adjusted to a predetermined close distance. Note that in the present specification, a state in which a predetermined close distance is in focus may be simply referred to as a close distance. The interval of each line in the optical axis direction indicates the clearance of each lens group. Accordingly, if the lines intersect, it indicates that the lens barrels holding the lens groups interfere with each other.

The driving of the fourth group lens barrel 122 that holds the fourth lens group L4, which is a focus lens, is controlled by the linear ultrasonic motor 124 so as to follow a line that is indicated as LA INFINITE in a state in which the focus is at infinity during zooming. In contrast, in a state in which a predetermined close distance is in focus, the driving of the fourth group lens barrel 122 is controlled by the linear ultrasonic motor 124 so as to follow a line indicated as LA CLOSE. Note that the position information for the fourth lens group L4 focused on each focus position from infinity to the close distance is stored as data. Based on this information and focal length information detected by the zoom sensor 106, the driving of the fourth group lens barrel 122 is controlled by the linear ultrasonic motor 124 so as to follow the line as shown in FIG. 5.

The driving of the fourth group lens barrel 122 that holds the fourth lens group L4 that serves as a focus lens is electrically controlled according to zooming, and the zooming is performed manually or by an external driving unit. Accordingly, in the case of zooming being performed at a high speed, there is a limit to the driving speed of the focus lens, and therefore, there are cases in which the focus lens is not in time for zooming. Note that in the case in which zooming is performed by a conventional built-in motor, the above-explained drawback does not occur due to the speed of the built-in motor being appropriately controlled.

In the lens barrel 100 according to the present embodiment, when each lens group is moved from the telephoto end to the wide angle end at a high speed in a state in which the focus is adjusted to a close distance, the fourth group lens barrel 122 is not driven in time, and the fourth group lens barrel 122 and the fifth group lens barrel 127 may interfere with each other. That is, in the present embodiment, the moving range of the fourth lens group L4 and the fifth lens group L5 overlap with each other by a predetermined amount. In FIG. 5, a range in which there is a possibility of interference is shown as an interference region. The maximum amount of interference is the amount of overlap in the optical axis direction between the position at the wide angle end (wide) of the movement locus (line indicated by L5) of the fifth lens group L5 held by the fifth group lens barrel 127 and the position at the telephoto end of the L4 CLOSE, and is the amount indicated by A in FIG. 5.

In the normal imaging state, this interference amount depends on the zooming speed and the speed of the actuator of the focus lens. It is assumed that the lens barrel 100 according to the present embodiment is applied to an interchangeable lens, and the lens barrel 100 is detached from the camera body 200 in a state in which the fourth lens group L4 is arranged at a close distance at the telephoto end. In this case, since the power is cut off, the fourth lens group L4 that serves as the focus lens cannot be driven. Therefore, when the fifth lens group L5 is moved to the position of the wide-angle end, interference occurs by an amount A as shown in FIG. 5.

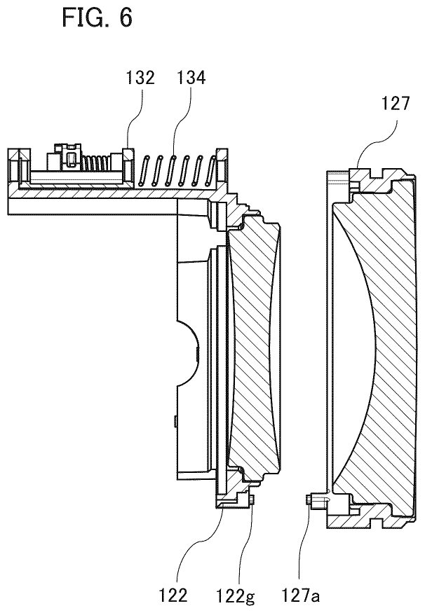

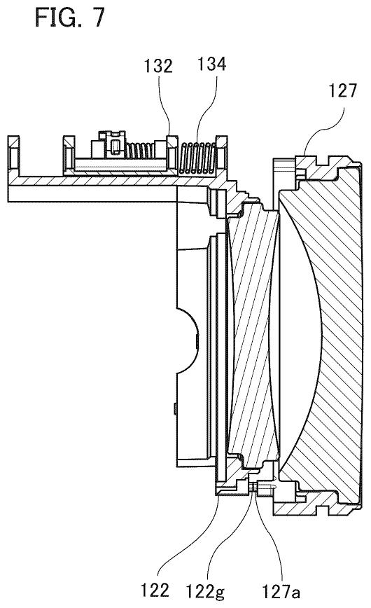

Next, an explanation will be given of a case in which the fourth group lens barrel 122 that holds the fourth lens group L4, which is a focus lens, interferes with the fifth group lens barrel 127 that holds the fifth group lens group L5. FIG. 6 is a cross-sectional view illustrating a state (normal state) in which the fourth group lens barrel 122 and the fifth group lens barrel 127 do not interfere with each other. FIG. 7 is a cross-sectional view illustrating a state (interference state) in which the fourth group lens barrel 122 and the fifth group lens barrel 127 interfere with each other.

When zooming is performed at a high speed from the telephoto end, or when power is shut off in a state in which the fourth lens group L4 is arranged at the close distance to the telephoto end and zooming is performed toward the wide-angle end as explained above, a contact portion 122g of the fourth group lens barrel 122 and a contact portion 127a that is provided in the fifth lens barrel 127 come into contact with each other as shown in FIG. 7. As a result, the fourth group lens barrel 122 is pushed in the optical axis direction by the fifth group lens barrel 127, and moves to the object side (the direction opposite to the side on which the fifth group barrel 127 is disposed). Then, the rack 131 and the rack holder 132 that are integrated with each other are held by the movable portion 126 of the linear ultrasonic motor 124, and the movable portion 126 is stationary due to the frictional force with the fixed portion 125, and therefore, the compression coil spring 134 is compressed. Then, the rack holder 132 and the fourth group lens barrel 122 become separated from each other in the optical axis direction, and the fourth group lens barrel 122 moves in the optical axis direction together with the fifth group lens barrel 127 (hereinafter, this state is referred to as retracting or a retracted state). Therefore, even if interference occurs, it is possible to prevent damage to the lens barrel, the rack, and the motor.

In a conventional lens barrel, an optical design is performed such that other lenses are not arranged in a drive range of a focus lens that is electrically driven. In other words, clearance from the other lens group is provided to prevent interference with the moving range of the focus lens at the telephoto end, and the same clearance is provided at the wide-angle end as well. In many cases, the amount of movement of the focusing lens at the wide-angle end is smaller than the amount of movement of the focusing lens at the telephoto end, and in many cases, an unnecessary clearance is opened at the wide-angle end, making the total length of the lens is increase by that amount.

In the lens barrel 100 according to the present embodiment, the rack holder 132 and the fourth group lens barrel 122 are configured to be separated from each other in the optical axis direction, such that interference to the focus lens is allowed when zooming is performed at a high speed. As a result, the unnecessary clearance between the lens groups can be set so as to be smaller, and is preferably minimized, and the entire lens barrel (length in the optical axis direction) can be set so as to be compact.

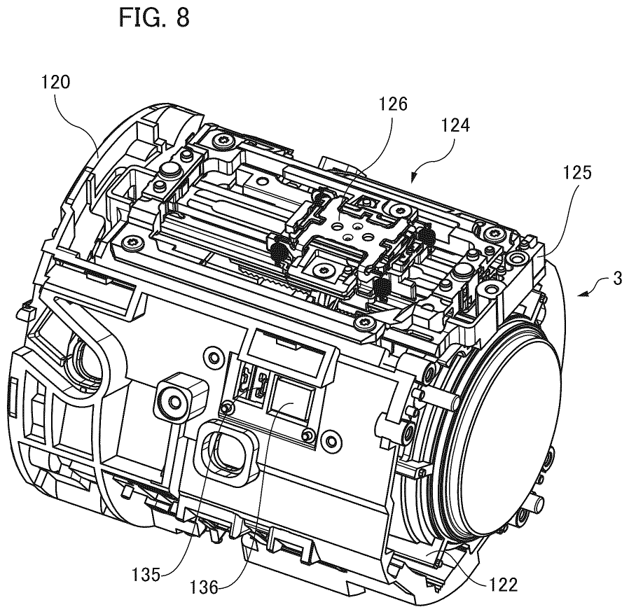

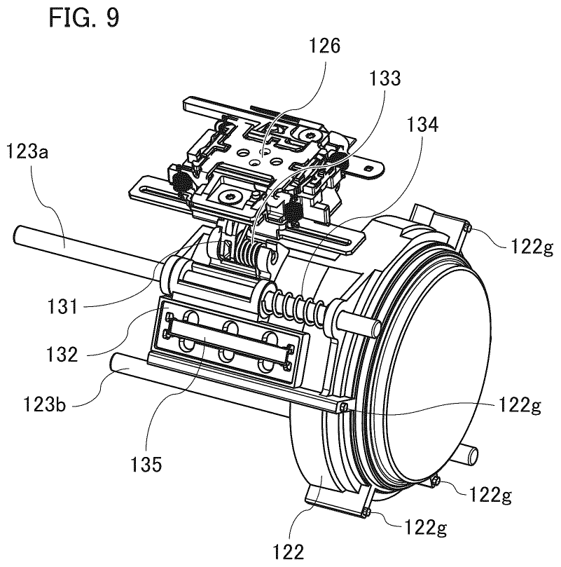

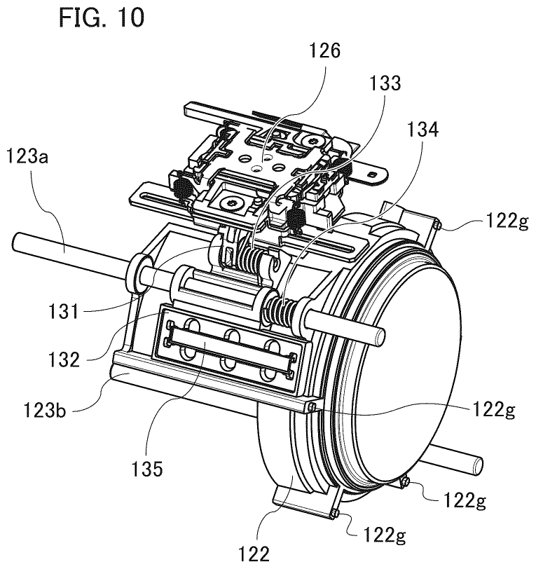

Next, a configuration of the focus unit 3 will be explained. FIG. 8 is a perspective view showing the normal state of a part of the focus unit 3. FIG. 9 is a cross-sectional view illustrating a normal state of the fourth group lens barrel 122 and the rack holder 132. FIG. 10 is a cross-sectional view illustrating an interference state between the fourth group lens barrel 122 and the rack holder 132.

The focus unit 3 includes the third group base lens barrel 120, the linear ultrasonic motor 124, a position sensor 136, the 3A group lens barrel 117 (illustrated in FIG. 1), the 3B group barrel 118 (illustrated in FIG. 1), the fourth group lens barrel 122, and the like. The holding of the 3A group lens barrel 117, the 3B group barrel 118, and the fourth group lens barrel 122 with respect to the third group base lens barrel 120 has been explained above, and the description thereof will be omitted.

The fixing portion 125 of the linear ultrasonic motor 124 is fixed to the third group base lens barrel 120 with a screw. A scale 135 is a component on which a continuous pattern has been formed in the optical axis direction. The scale 135 is adhesively fixed to the rack holder 132. The position sensor 136 detects a relative positional relationship between the position sensor 136 and the scale 135 by reading the scale 135. Specifically, the relative position of the rack holder 132 with respect to the third group base lens barrel 120 in the optical axis direction can be detected by reading the pattern of the scale 135 using the position sensor 136 that is attached to the third group base barrel 120. That is, the scale 135 and the position sensor 136 are absolute value sensors capable of detecting an absolute value. Here, although an absolute value sensor of the optical pulse count system is used as an example, an absolute value sensor of the magnetic pulse count system may be used. The relative position of the rack holder 132 is detected by reading the pattern of the scale 135 using the position sensor 136. Accordingly, the scale 135 has a length that is equal to or longer than a distance (driving amount) between a position of the fourth lens group L4 closest to the object side and a position of the fourth lens group L4 closest to the image side in the entire zoom range, in the optical axis direction. In the case that is shown in FIG. 5, the fourth lens group L4 is positioned closest to the object side when it is set to TELE infinity and the fourth lens group L4 is positioned closest to the image side when it is set to TELE close.

In a normal state in which no interference occurs, the rack holder 132 and the fourth group lens barrel 122 are integrally movable. Therefore, in the normal state, it is also possible to detect the relative position of the fourth group lens barrel 122 with respect to the third group base lens barrel 120 in the optical axis direction using the position sensor 136. In contrast, in the interference state, the relative position between the rack holder 132 and the fourth group lens barrel 122 is different from the relative position in the normal state. Specifically, in the interference state, the relationship between the relative positions of the rack holder 132 and the third group base lens barrel 120 that is detected by the position sensor 136 and the scale 135 is different from the relationship between the relative positions of the fourth group lens barrel 122 and the third group base barrel 120.

As explained above, errors that occur between the position sensor 136 and the scale 135 can be reduced by the position of the rack holder 132 to which the scale 135 is fixed being determined by the guide bar 123a that is fixed to the third group base lens barrel 120. Although the number of components is increased by forming the intermediate member into two members, the detection accuracy is sensitive to deviations in the distance between the position sensor 136 and the scale 135, and therefore the deterioration of the focus detection accuracy can be suppressed by forming the intermediate member into two members.

Next, a control method for the linear ultrasonic motor 124 will be explained. Conventionally, in general, the position of the fourth group lens barrel 122 is detected by a scale that is provided in the fourth group lens barrel 122, and feedback control is performed based on a difference between a drive command position and an actual position. When the scale is provided in the fourth group lens barrel 122, even if the linear ultrasonic motor 124 is driven in the interference state, a state in which the position of the fourth group lens barrel 122 acquired from the scale does not change continues, and a large deviation occurs in the feedback control. Additionally, when an attempt is made to perform driving with a large thrust force so as to reduce the deviation, this causes the drawbacks of a sound occurring at the time of collision, a noise occurring at the time of driving, and control oscillation occurring.

As was explained above, in the present embodiment, in the normal state in which no interference occurs, since the rack holder 132 to which the scale 135 is fixed and the fourth group lens barrel 122 move integrally with one another, conventional feedback control is performed based on the output result of the position sensor 136. In contrast, even in the interference state, when the linear ultrasonic motor 124 is driven, since the rack holder 132 is held by the movable portion 126, the position of the rack holder 132 that is acquired from the scale 135 changes. At this time, since the fourth group lens barrel 122 moves integrally with the fifth group barrel 127, the position of the fifth group barrel 127 can be known from the detection result of the zoom sensor 106, and the position of the fourth group barrel 122 can be also known. Thus, the positions of the rack holder 132 and the fourth group lens barrel 122 can be known even in the interference state. As a result, the amount of interference can be calculated from the difference in positions between the rack holder 132 and the fourth group lens barrel 122.

As was described above, the scale 135 is disposed in the rack holder 132, and therefore feedback control can be performed even in the interference condition. Additionally, it is possible to quickly perform the return operation to the normal state while suppressing deteriorations in quality such as the position accuracy and the driving sound by changing the driving speed, the acceleration, and the like according to the interference amount. Furthermore, the position deviation does not become large during the drive control, and oscillation due to the position deviation does not occur.

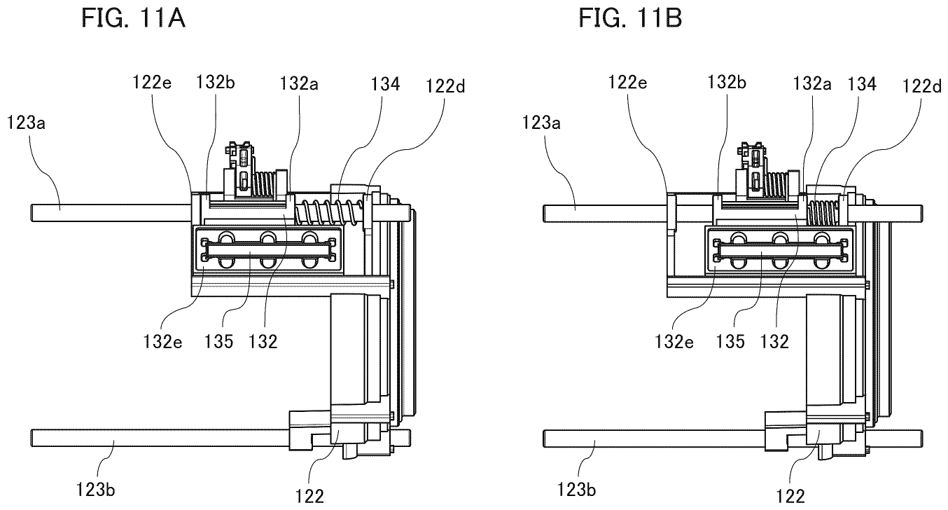

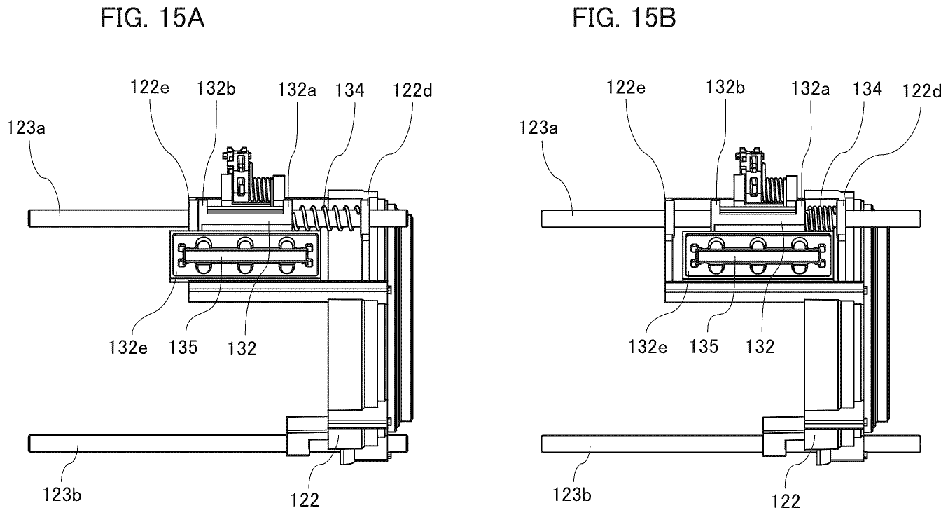

Next, the disposition of the scale 135 in the optical axis direction, which is a primary element of the present invention, will be explained. FIG. 15A and FIG. 15B are diagrams explaining an increase in size due to the disposition of the scale 135 in the optical axis direction. FIG. 15A shows the normal state, and FIG. 15B shows the interference state. Additionally, FIG. 11A and FIG. 11B are diagrams explaining downsizing due to the disposition of the scale 135 in the optical axis direction according to the first embodiment. FIG. 11A shows the normal state according to the present embodiment, and FIG. 11B shows the interference state according to the present embodiment.

As shown in FIG. 15A, a case will be considered in which a scale holding portion 132e of the rack holder 132 that holds the scale 135 is disposed such that, in a normal state, the center of the scale 135 in the optical axis direction and the center between the sleeve hole 132a and the sleeve hole 132b are at the same position (overlapping position) in the optical axis direction. In this case, as shown in FIG. 15A, in the normal state, the scale holding portion 132e protrudes to the object side with respect to the sleeve hole 122e of the fourth group lens barrel 122. In such a disposition, it is necessary to avoid the protrusion of the scale holding portion 132e toward the object side so as not to interfere with the 3B group lens barrel 118 on the object side. If an attempt is made to avoid such a situation by providing cutout in the radial direction, the degree of freedom in the design deteriorates. Additionally, if such a situation cannot be avoided even if the cutout is provided it is necessary to provide a space in the optical axis direction, and thus the size of the lens barrel increases in the optical axis direction. As the amount of protrusion of the scale holding portion 132e toward the object side increases, the amount of increase in size also increases.

In contrast, in the configuration according to the present embodiment, the end portion (the surface on the object side) of the scale holding portion 132e is positioned so as to overlap with the sleeve hole 122e of the fourth group lens barrel 122 in the optical axis direction in the normal state, as shown in FIG. 11A. In other words, in the normal state, the center of the scale 135 in the optical axis direction is positioned on the fifth group lens barrel 127 side (image plane side) with respect to the center between the sleeve hole 132a and the sleeve hole 132b. With such a positioning, the space on the object side of the fourth group lens barrel 122 and the rack holder 132 is determined by the position of the sleeve hole 122e of the fourth group lens barrel 122 in the optical axis direction. Therefore, it is not necessary to avoid the 3B group lens barrel 118 that is arranged on the object side.

Additionally, as shown in FIG. 11B, it is preferable that, in the interference state, the rack holder 132 is disposed in such a manner that a part of the rack holder 132 and the sleeve hole 122d overlap in the optical axis direction. With such a disposition, even during interference, the scale 135 stays within the range of the space that is used by the fourth group lens barrel 122 in the normal state, and it is therefore not necessary to avoid the fifth group lens barrel 127 that is located on the image plane side, or the amount for avoidance is reduced. Note that if the rack holder 132 significantly protrudes toward the fifth group lens barrel 127 side in the interference state, it is necessary to avoid the fifth group lens barrel 127. For this reason, it is more preferable that, in the interference state, the rack holder 132 is disposed at a position where the rack holder 132 does not protrude toward the image plane side (the fifth group lens barrel 127 side) with respect to the fourth group lens barrel 122.

As was described above, the object side surface of the scale holding portion 132e is positioned so as to overlap the sleeve hole 122e of the fourth group lens barrel 122, so that the space of the fourth group lens barrel 122 and the rack holder 132 in the optical axis direction can be reduced. As a result, the lens barrel can be reduced in size in the optical axis direction.

Here, even if the scale holding portion 132e is disposed at a position protruding toward the object side with respect to the sleeve hole 122e, the same effect is achieved if the center of the scale 135 is positioned on the imaging surface side with respect to the center between the sleeve hole 132a and the sleeve hole 132b in the normal state. Additionally, the scale holding portion 132e may be disposed in such a manner that the surface on the object side is positioned toward the imaging surface side with respect to the sleeve hole 122e in the normal state. Furthermore, the scale 135 may be disposed on the third group base lens barrel 120, and the position sensor 136 may be disposed on the rack holder 132.

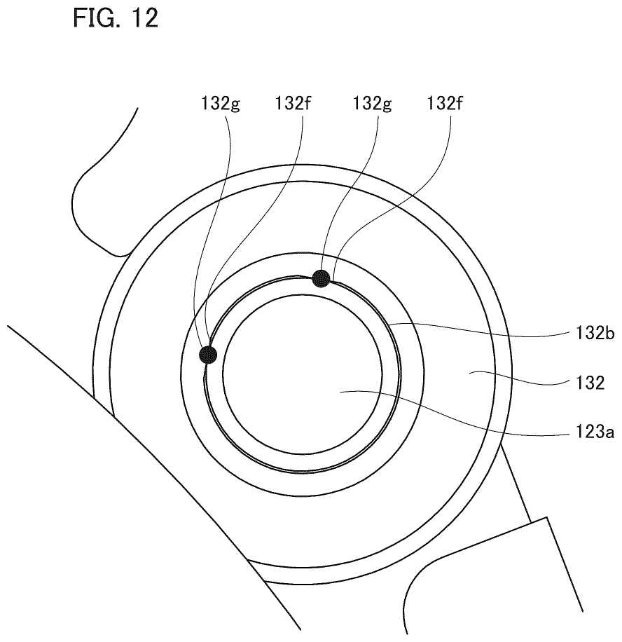

FIG. 12 is a diagram explaining a relationship between a sleeve hole 132a, a sleeve hole 132b, and a guide bar 123a. FIG. 12 shows a view of the sleeve hole 132b and the guide bar 123a in a plane that is orthogonal to the optical axis. It is preferable that the sleeve hole 132b has two surfaces 132f on its inner periphery so that the guide bar 123a comes into contact with two contact points 132g. It is preferable that the sleeve hole 132a has a similar configuration. With such a configuration, it is possible to prevent the positions of the rack holder 132 and the guide bar 123a from being changed even when the orientation of the lens barrel is changed, and consequently, it is possible to suppress deterioration in focus accuracy that is caused by a change in orientation.

Although the retraction range in the present embodiment corresponds to the range A in FIG. 5 and is present on the imaging surface side in the optical axis direction, the retraction range may be present on the object side or may also be present on both sides.

In the present embodiment, although an ultrasonic motor is employed to drive the fourth group lens barrel 122, a similar effect can be obtained even if a driving unit such as a stepping motor is employed.

### Second Embodiment

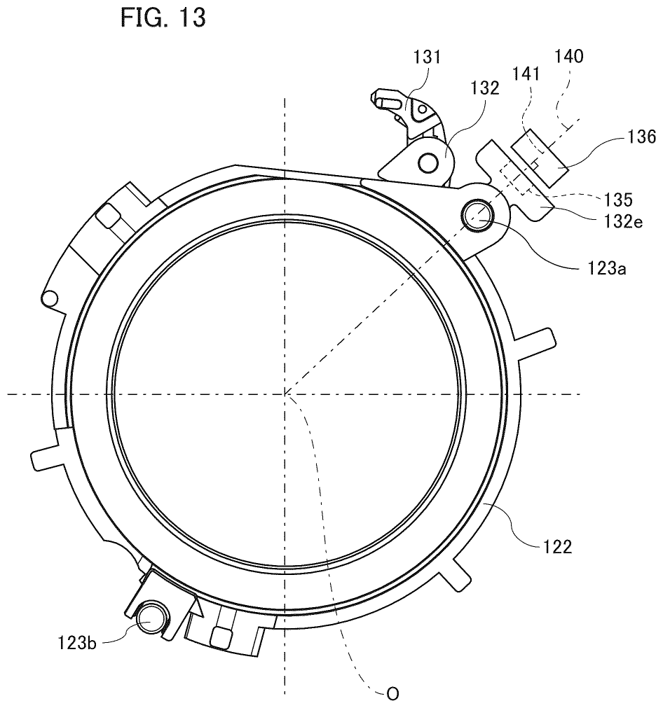

Hereinafter, only differences between the lens barrel 100 according to the second embodiment of the present invention and the lens barrel 100 according to first embodiment will be explained. FIG. 13 is a diagram showing the disposition of the scale holding portion 132e in the direction that is orthogonal to the optical axis in the second embodiment. FIG. 13 shows the fourth group lens barrel 122 in a plane orthogonal to the optical axis. As shown in FIG. 13, the second embodiment is different from the first embodiment in the disposition of the scale holding portion 132e in the direction that is orthogonal to the optical axis.

In the present embodiment, the detection surface of the position sensor 136 is positioned substantially perpendicular to a line 141 that connects the center of the guide bar 123a and the center of the position sensor 136 in the direction that is orthogonal to the optical axis. With such a positioning, when the rack holder 132 rotates around the guide bar 123a, a change in the distance between the position sensor 136 and the scale 135 can be reduced, thereby improving the focus detection accuracy.

Additionally, the scale 135 is disposed on an extension of a line 140 that connects the optical axis center O and the center of the guide bar 123a in the direction that is orthogonal to the optical axis. With such a disposition, the space that is occupied by the rack holder 132 in the circumferential direction can be reduced. Here, the scale 135 may be disposed on the linear ultrasonic motor 124 side with respect to the extension line of the line 140 that connects the optical axis center O and the center of the guide bar 123a. Note that although, in FIG. 13, the line 140 and the line 141 overlap with each other, there are also cases in which the line 140 and the line 141 do not overlap with each other.

Additionally, the scale holding portion 123a is disposed between the position sensor 136 and the guide bar 132e in the direction that is orthogonal to the optical axis. If the position sensor 136 is of a light emitting type, this disposition can prevent ghost flares from being generated by reflection off of the guide bar 123a.

### <Embodiment of Imaging Apparatus>

FIG. 14 is a diagram illustrating an example of a configuration of an imaging apparatus 300. An imaging apparatus having the effect of the present invention can be realized by the imaging apparatus 300 having the lens barrel 100 of the above-described embodiment and the camera body 200 that holds an imaging element 210 that receives light from the lens barrel 100.

### Other Embodiments

Although preferred embodiments of the present invention have been explained above, the present invention is not limited to these embodiments, and various modifications and changes can be made within the scope of the gist thereof.

In the embodiments as explained above, although a lens barrel that serves as an interchangeable lens for capturing a still image and a moving image has been explained, the same effect can be obtained when manual zooming is performed in a lens barrel that records an image. Additionally, the present invention is not limited to the focus lens in the lens barrel, and can be applied to other lenses that move by zooming, and can also applied to a case in which the lens barrel is downsized by contact with a fixed portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-008190, filed Jan. 23, 2024, which is hereby incorporated by reference herein in its entirety.

What is claimed is:

1. A lens barrel comprising:
a first lens group configured to be movable in an optical axis direction, which is a direction along an optical axis;
a second lens group configured to be adjacent to the first lens group in the optical axis direction, to be movable in the optical axis direction, and to have a movement range that overlaps with a movement range of the first lens group by a predetermined amount;
a first holding member configured to hold the first lens group;
a second holding member configured to hold the second lens group;
a driving unit configured to move the first holding member in the optical axis direction;
a first intermediate member and a second intermediate member configured to move by a driving force of the driving unit and transmit the driving force to the first holding member;
a first biasing member configured to bias the first intermediate member toward the driving unit and bias the second intermediate member toward the first holding member;
a second biasing member configured to bias the first holding member in the optical axis direction with respect to the second intermediate member;
a guide shaft member configured to movably hold the second intermediate member and the first holding member and guide movement thereof; and
a detection unit configured to detect a position of the second intermediate member in the optical axis direction and a unit to be detected,
wherein the second biasing member enables the first holding member to be retracted by at least the predetermined amount in a direction opposite to a side on which the second holding member is disposed with respect to the second intermediate member, and
wherein one of the detection unit and the unit to be detected is disposed on the second intermediate member.

2. The lens barrel according to claim 1,
wherein the second intermediate member has two intermediate member guide portions through which the guide shaft member is inserted, and
wherein, in the optical axis direction, the center of the unit to be detected in the optical axis direction is positioned to the second holding member side with respect to the center between the two intermediate member guide portions in the optical axis direction.

3. The lens barrel according to claim 2, wherein the intermediate member guide portion comes into contact with the guide shaft member at two contact points.

4. The lens barrel according to claim 1,
wherein the first holding member has a first holding member guide portion and a second holding member guide portion through which the guide shaft member is inserted,
wherein the first holding member guide portion is disposed on the second holding member side with respect to the second holding member guide portion, and
wherein if the first holding member is in a state of being retracted by the predetermined amount with respect to the second intermediate member, the second intermediate member and the first holding member guide portion overlap with each other in the optical axis direction.

5. The lens barrel according to claim 4, wherein in a state in which the first holding member is not retracted with respect to the second intermediate member, an end portion of the second intermediate member on a side opposite to the second holding member overlaps with the second holding member guide portion in the optical axis direction or is positioned more toward the second holding member side than the second holding member guide portion in the optical axis direction.

6. The lens barrel according to claim 1,
wherein the detection unit detects a relative positional relationship between the detection unit and the unit to be detected by reading the unit to be detected, and
wherein the unit to be detected has a length that is equal to or longer than a length corresponding to a driving amount of the first lens group in the optical axis direction.

7. The lens barrel according to claim 1, wherein a detection surface of the detection unit is positioned so as to be substantially perpendicular to a line connecting the center of the guide shaft member and the center of the detection unit in a plane that is orthogonal to the optical axis.

8. The lens barrel according to claim 1, wherein the unit to be detected is disposed on an extension line of a line connecting the optical axis and the center of the guide shaft member or on the driving unit side with respect to the extension line in a plane that is orthogonal to the optical axis.

9. The lens barrel according to claim 1, wherein the second intermediate member is disposed between the detection unit and the guide shaft member in a plane that is orthogonal to the optical axis.

10. The lens barrel according to claim 1, further comprising a focal length detection unit configured to detect a focal length;
wherein a relative position between the first holding member and the second intermediate member in the optical axis direction is calculated based on detection results of the detection unit and the focal length detection unit.

11. The lens barrel according to claim 1, wherein the second biasing member is an elastic member.

12. The lens barrel according to claim 1, wherein the unit to be detected is disposed on the second intermediate member.

13. The lens barrel according to claim 1,
wherein the first lens group is a lens group that moves during focus adjustment, and
wherein the second lens unit is a lens unit that moves during zooming.

14. An imaging apparatus comprising:
a lens barrel; and
an imaging element configured to receive an image formed by the lens barrel,
the lens barrel comprising:
a first lens group configured to be movable in an optical axis direction, which is a direction along an optical axis;
a second lens group configured to be adjacent to the first lens group in the optical axis direction, to be movable in the optical axis direction, and to have a movement range that overlaps with a movement range of the first lens group by a predetermined amount;
a first holding member configured to hold the first lens group;
a second holding member configured to hold the second lens group;
a driving unit configured to move the first holding member in the optical axis direction;
a first intermediate member and a second intermediate member configured to move by a driving force of the driving unit and transmit the driving force to the first holding member;
a first biasing member configured to bias the first intermediate member toward the driving unit and bias the second intermediate member toward the first holding member;
a second biasing member configured to bias the first holding member in the optical axis direction with respect to the second intermediate member;
a guide shaft member configured to movably hold the second intermediate member and the first holding member and guide movement thereof; and
a detection unit configured to detect a position of the second intermediate member in the optical axis direction and a unit to be detected,
wherein the second biasing member enables the first holding member to be retracted by at least the predetermined amount in a direction opposite to a side on which the second holding member is disposed with respect to the second intermediate member, and
wherein one of the detection unit and the unit to be detected is disposed on the second intermediate member.
